(19) United States
(12) Patent Application Publication
(10) Pub. No.: US 2024/0286252 A1
(43) Pub. Date: Aug. 29, 2024

(54) Ratchet Wrench With Dual Slotted Heads

(71) Applicant: Charlie Wook Ahn, Centreville, VA (US)

(72) Inventor: Charlie Wook Ahn, Centreville, VA (US)

(21) Appl. No.: 18/440,670

(22) Filed: Feb. 13, 2024

Related U.S. Application Data
(60) Provisional application No. 63/576,613, filed on Feb. 23, 2023.

(51) Int. Cl. B25B 13/46; B25B 13/48

(52) U.S. Cl. CPC B25B 13/467; B25B 13/462; B25B 13/481

(57) ABSTRACT

A ratchet wrench for turning a fastener. The wrench comprises a handle, a left head at the left end of the handle, and a right head at the right end of the handle. The left head comprises a left socket part. The right head comprises a right socket part. The left socket part is rotatable within the left head in a first direction (e.g. clockwise or counter-clockwise), but rotationally locked in a second direction. The right socket part is rotatable within the right head in the second direction, but rotationally locked in the first direction.

### TECHNICAL FIELD

This invention relates to wrench tools.

### BACKGROUND

Traditional socket ratchet wrenches typically consist of a handle, a ratcheting mechanism, and interchangeable sockets of various sizes. While these tools have proven indispensable in mechanical and repair tasks, there are certain limitations and drawbacks associated with conventional designs. One common issue is the limited access to confined spaces. As such, there remains a need for an innovative ratchet wrench design that addresses the limitations of conventional models.

### SUMMARY

This invention provides a ratchet wrench for turning a fastener. Examples of fasteners include nuts, bolts, screws, etc. The wrench comprises a handle, a first head at a first end of the handle, and a second head at a second end of the handle. The first head comprises a first head gear teeth, a first hole, and a first head slot that is an opening at a lateral side of the first head that merges with the first hole. The first head further comprises a first socket part within the first head. The first socket part comprises a first socket gear teeth that engages with the first head gear teeth and a first socket cavity for receiving a fastener. The first socket part further comprises a first socket slot that is an opening at a side of the first socket part. The first head gear teeth and the first socket gear teeth are configured such that the first socket part is rotatable within the first head in a first direction (e.g. clockwise or counter-clockwise), but rotationally locked in a second direction.

The second head has corresponding features as the first head. These features may be symmetric with those of the first head. The second head gear teeth and the second socket gear teeth are configured such that the second socket part is rotatable within the second head in the second direction, but rotationally locked in the first direction.

### BRIEF DESCRIPTION OF THE DRAWINGS

FIG. 1 shows an example ratchet wrench of this invention as disassembled.

FIGS. 2A and 2B show a socket part.

FIG. 3 shows how the ratchet wrench could be used.

FIG. 4 shows a side view of the ratchet wrench.

FIG. 5 shows a side view of an alternate design for the ratchet wrench.

FIGS. 6A and 6B show variations in the design of the gear teeth.

### DETAILED DESCRIPTION OF EXAMPLE EMBODIMENTS

Drawings are provided to help understand the invention and illustrate specific representative examples. The drawings herein are not necessarily made to scale or actual proportions. For example, the size of components may be adjusted to accommodate the page size.

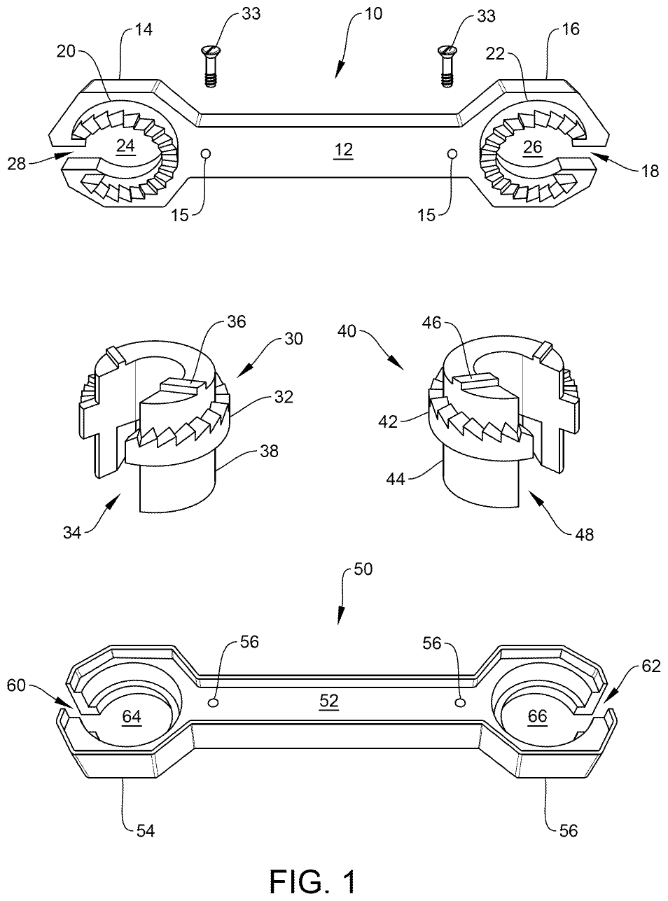

FIG. 1 shows an example ratchet wrench of this invention as disassembled. The ratchet wrench comprises an upper member 10 (bottom perspective view), socket part 30 (top perspective view), socket part 40 (top perspective view), and lower member 50 (top perspective view).

Upper member 10 comprises a handle portion 12. On the left side of upper member 10, there is a left-side head portion 14. For receiving socket part 30, left-side head portion 14 has a circular hole 24. On the bottom side of head portion 14, a ridge with gear teeth 20 wraps around the edge of circular hole 24. On the lateral side of head portion 14, there is an open slot 28 that merges with circular hole 24.

The right side of upper member 10 has a corresponding symmetrical configuration. Upper member 10 of the ratchet wrench further has a right-side head portion 16. For receiving socket part 40, right-side head portion 16 has a circular hole 26. On the bottom side of head portion 16, a ridge with gear teeth 22 wraps around the edge of circular hole 26. On the lateral side of head portion 16, there is an open slot 18 that merges with circular hole 26.

Circular hole 24 on head portion 14 receives a socket part 30, which comprises a cylindrical-shaped main body 38. On top of main body 38, socket part 30 has two knobs 36 so that the user can twist for rotating socket part 30. On the bottom of main body 38, socket part 30 has a socket cavity for receiving a fastener. There is a pie-shaped “cutout” slot 34 extending through socket part 30 that is open from top to bottom. Socket part 30 also has a ridge with gear teeth 32 that wraps around main body 38. Gear teeth 32 of socket part 30 engages with gear teeth 20 on the bottom side of head portion 14 of upper member 10.

Circular hole 26 on head portion 16 receives a socket part 40, which comprises a cylindrical-shaped main body 44. On top of main body 44, socket part 40 has two knobs 46 so that the user can twist for rotating socket part 40. On the bottom of main body 44, socket part 40 has a socket cavity for receiving a fastener. There is a pie-shaped “cutout” slot 48 extending through socket part 40 that is open from top to bottom. Socket part 40 also has a ridge with gear teeth 42 that wraps around main body 44. Gear teeth 42 of socket part 40 engages with gear teeth 22 on the bottom side of head portion 16 of upper member 10.

Lower member 50 comprises a handle portion 52. On the left side of lower member 50, there is a left-side head portion 54. For receiving socket part 30, left-side head portion 54 has a circular hole 64. On the lateral side of head portion 54, there is an open slot 60 that merges with circular hole 64. Open slot 60 is aligned with open slot 28 of head portion 14 of upper member 10.

On the right side of lower member 50, there are corresponding structural features: right-side head portion 56, circular hole 66 for receiving socket part 40, and open slot 62 on the lateral side of head portion 56 that merges with circular hole 66. Open slot 62 is aligned with open slot 18 of head portion 16 of upper member 10.

Lower member 50 mates with upper member 10 and are held together by screws 33, which fit through screw holes 15 of upper member 10 and screw holes 56 of lower member 50. Socket parts 30 and 40 are encased between upper member 10 and bottom member 50. Socket part 30 is contained in head portions 14 and 54. Socket part 40 is contained in head portions 16 and 56. Because of the configuration of the gear teeth, socket part 30 is rotatable in a clockwise direction, but is rotationally locked in the counter-clockwise direction. Socket part 40 is rotatable in a counter-clockwise direction, but is rotationally locked in the clockwise direction.

When upper member 10 and lower member 50 are assembled together, left head portion 14 and left head portion 54 together become the left wrench head. Right head portion 16 and right head portion 56 together become the right wrench head. Circular hole 24 and circular hole 64 on the left side together become the circular hole for the left wrench head. Socket part 30 fits within this circular hole for the left wrench head.

Likewise, circular hole 26 and circular hole 66 on the right side together become the circular hole for the right wrench head. Socket part 40 fits within this circular hole for the right wrench head. Open slot 28 and open slot 60 for the left side together become the open slot for the left wrench head. Likewise, open slot 18 and open slot 62 for the right side together becomes the open slot for the right wrench head.

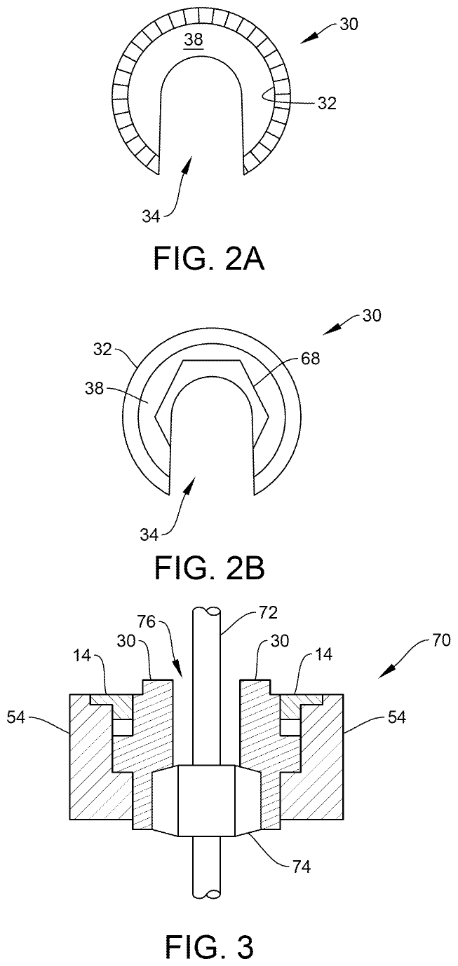

FIG. 2A shows a top view of socket part 30. This view shows open slot 34 more clearly. FIG. 2B shows a bottom view of socket part 30. This view shows hexagon-shaped socket cavity 68 more clearly. Socket part 40 has corresponding features.

FIG. 3 shows how the ratchet wrench could be used. This is a cross-section side view of the ratchet wrench on the left side wrench head. In this view, head portion 14 of upper member 10 and head portion 54 of lower member 50 together become wrench head 70. Also in this view, circular hole 24 of head portion 14 and circular hole 64 of head portion 54 together become the wrench head hole. Also, open slot 28 of head portion 14 and open slot 60 of head portion 54 together become lateral head slot 76. Socket part 30 is rotated so that its “cutout” slot 34 aligns with head slot 76.

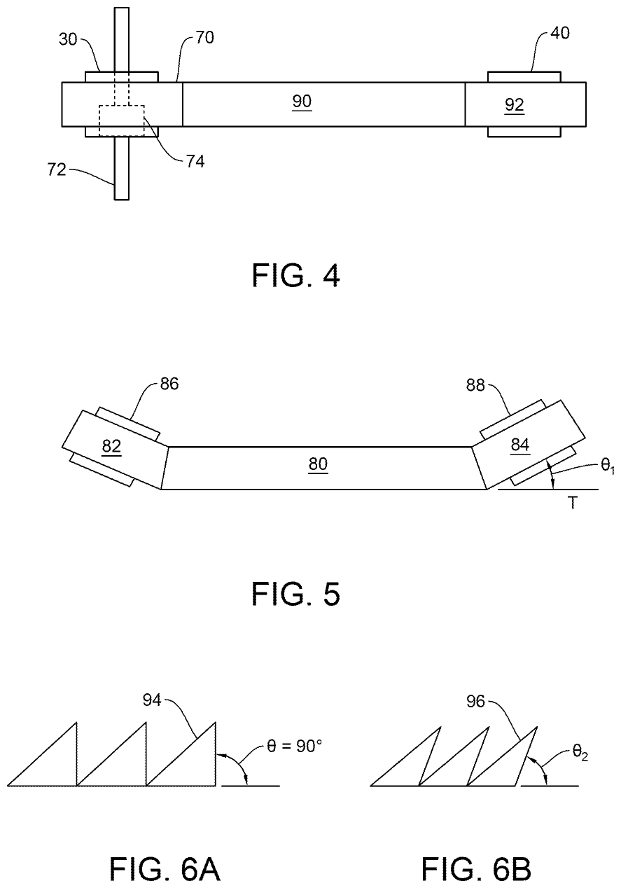

A nut 74 is installed on a threaded rod 72. Via head slot 76, wrench head 70 is introduced to threaded rod 72 and positioned inside the wrench head hole. The user then guides the ratchet wrench down along threaded rod 72 so that nut 74 goes into socket cavity 68. The user then twists the wrench to turn nut 74. The ratchet wrench may be flipped around and the wrench head on the other side could be used to turn nut 74 in the opposite direction. FIG. 4 shows a side view of the ratchet wrench with left-side wrench head 70 engaged with nut 74 and rod 72. Also shown here are the wrench handle 90, right-side wrench head 92, socket part 30, and socket part 40.

FIG. 5 shows a side view of an alternate design for the ratchet wrench. In this design, the ratchet wrench comprises a handle 80, a left-side wrench head 82, a right-side wrench head 84, a left-side socket part 86 contained in wrench head 82, and a right-side socket part 88 contained in wrench head 84. See that wrench heads 82 and 84 are angled relative to the plane of the handle 80. FIG. 5 also demonstrates how the angle θ₁ between the plane T of the handle 80 and the plane of right-side wrench head 84 can be measured. For example, the angle θ₁ (for either or both of wrench heads 82 and 84) could be in the range of 5-45°.

FIGS. 6A and 6B show variations in the design of the gear teeth, which may be applicable to any of the gear teeth in the ratchet wrench. In FIG. 6A, the gear teeth 94 are set at 90° angle. In FIG. 6B, the gear teeth 96 are set at less than 90° angle. For example, the angle θ₂ could be in the range of 60-87°.

The foregoing description and examples merely illustrate the invention and are not intended to be limiting. Each of the disclosed aspects and embodiments of the invention may be considered individually or in combination with other aspects, embodiments, and variations of the invention. Also, unless otherwise specified, the steps of the methods of the invention are not limited to any particular order of performance. Persons skilled in the art may perceive modifications to these embodiments that incorporate the spirit and substance of the invention. Such modifications are within the scope of the invention.

Any use of the word “or” herein is intended to be inclusive and is equivalent to the expression “and/or,” unless the context clearly indicates otherwise. As such, for example, the expression “A or B” means A, or B, or both A and B. Similarly, for example, the expression “A, B, or C” means A, or B, or C, or any combination thereof.

The terms “first, second, etc.” with respect to elements may be used herein merely to distinguish one element from another element. Unless the context indicates otherwise, these are not intended to limit the elements regarding their composition or ordinal arrangement, such as defining the order, position, or priority of the elements.

1. A ratchet wrench comprising:
(a) a handle
(b) a first head at a first end of the handle, wherein the first head comprises:
a first head gear teeth;
a first hole;
a first head slot that is an opening at a lateral side of the first head that merges with the first hole;
(c) a first socket part within the first head, wherein the first socket part comprises:
a first socket gear teeth that engages with the first head gear teeth;
a first socket cavity for receiving a fastener;
a first socket slot that is an opening at a side of the first socket part;
(d) wherein the first head gear teeth and the first socket gear teeth are configured such that the first socket part is rotatable within the first head in a first direction, but rotationally locked in a second direction;
(e) a second head at a second end of the handle, wherein the second head comprises:
a second head gear teeth;
a second hole;
a second head slot that is an opening at a lateral side of the second head that merges with the second hole;
(f) a second socket part within the second head, wherein the second socket part comprises:
a second socket gear teeth that engages with the second head gear teeth;
a second socket cavity for receiving a fastener;
a second socket slot that is an opening at a side of the second socket part;
(g) wherein the second head gear teeth and the second socket gear teeth are configured such that the second socket part is rotatable within the second head in the second direction, but rotationally locked in the first direction.

2. The ratchet wrench of claim 1, wherein the first head gear teeth and the first socket gear teeth each have a teeth angle of about 90°.

3. The ratchet wrench of claim 1, wherein the second head gear teeth and the second socket gear teeth each have a teeth angle of about 90°.

4. The ratchet wrench of claim 1, wherein the first head gear teeth and the first socket gear teeth each have a teeth angle of less than 90°.

5. The ratchet wrench of claim 4, wherein the first head gear teeth and the first socket gear teeth each have a teeth angle in the range of 60-87°.

6. The ratchet wrench of claim 1, wherein the second head gear teeth and the second socket gear teeth each have a teeth angle of less than 90°.

7. The ratchet wrench of claim 6, wherein the second head gear teeth and the second socket gear teeth each have a teeth angle in the range of 60-87°.

8. The ratchet wrench of claim 1, wherein the first direction is a clockwise direction and the second direction is a counter-clockwise direction.

9. The ratchet wrench of claim 1, wherein the first direction is a counter-clockwise direction and the second direction is a clockwise direction.

10. The ratchet wrench of claim 1, wherein the first socket cavity and the second socket cavity are hexagonal-shaped.

11. The ratchet wrench of claim 1, wherein the first head is angled relative to the handle.

12. The ratchet wrench of claim 11, wherein the angle of the first head is in the range of 5-45°.

13. The ratchet wrench of claim 11, wherein the second head is angled relative to the handle.

14. The ratchet wrench of claim 13, wherein the angle of the second head is in the range of 5-45°.

15. The ratchet wrench of claim 1, wherein the first head gear teeth wraps around the first hole and the second head gear teeth wraps around the second hole.

16. A method of turning a fastener, comprising:
having a ratchet wrench of claim 1;
engaging the first socket cavity with the fastener;
turning the ratchet wrench in the second direction to turn the fastener.

17. The method of claim 16, further comprising:
disengaging the first socket cavity from the fastener;
engaging the second socket cavity with the fastener;
turning the ratchet wrench in the first direction to turn the fastener.

18. The method of claim 16, further comprising aligning the first head slot with the first socket slot.

19. The method of claim 18, wherein the fastener is installed on a threaded rod, and the method further comprises positioning the threaded rod in the first hole of the first head via the first head slot.

20. The method of claim 18, further comprising aligning the second head slot with the second socket slot.
